(19) United States
(12) Patent Application Publication
(10) Pub. No.: US 2026/0099441 A1
(43) Pub. Date: Apr. 9, 2026

(54) GARBAGE COLLECTION HANDLING FOR FDP COMPLIANT SSD

(71) Applicant: Micron Technology, Inc., Boise, ID (US)

(72) Inventors: Hui Ye, Shanghai (CN); Meng Wei, Shanghai (CN)

(21) Appl. No.: 18/910,887

(22) Filed: Oct. 9, 2024

(51) Int. Cl. G06F 12/02; G06F 12/0802

(52) U.S. Cl. CPC G06F 12/0253; G06F 3/0679; G06F 12/0802; G06F 2212/60; G06F 2212/7205

(57) ABSTRACT

A memory sub-system controller performs garbage collection on flexible data placement (FDP) compliant memory sub-systems, such as solid state drives (SSDs). The controller stores a set of data across a plurality of memory components of a set of memory components, a first of the plurality of components being configured to store data in a first set of regions using a first write cursor, and a second of the plurality of components being configured to store data in a second set of regions using a second write cursor. The controller programs data, received from a host system, in a first portion of the first set of regions using the first write cursor. The controller relocates previously programmed data from a second portion of the first set of regions to the first portion of the first set of regions using the first write cursor.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components. Some memory sub-systems are flexible data placement (FDP compliant and arrange their memory components into reclaim groups (RGs), each of which includes sets of reclaim units (RUs). Such memory sub-systems enable a host to control the physical location (e.g., by RG and/or RU via an RU handle) into which data is programmed.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example RG system implementation of the memory sub-system, in accordance with some examples.

FIG. 4 is a block diagram of an example of garbage collection operations, in accordance with some examples.

FIGS. 5 and 6 are flow diagrams of example methods for performing garbage collection operations, in accordance with some examples.

FIG. 7 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Examples of the present disclosure configure a system component, such as a memory sub-system controller (and/or host), to perform garbage collection operations on an FDP compliant memory sub-system. The controller can program data to different sets of physical regions of the memory sub-system that are specified in commands received from a host system. The controller can program the data to each region of the different sets of physical regions using a respective write cursor (e.g., RU handle). Specifically, the controller can program data to a first portion of an individual set of regions using a first write cursor and can program data to a second portion of an individual set of regions using a second write cursor. In response to determining that garbage collection operations are needed for the individual set of regions (e.g., when a maximum number of regions have been programmed in the individual set of regions), the controller can relocate valid data from a second portion of the individual set of regions to the first portion of the individual set of regions using the first write cursor. Namely, the controller can use the same write cursor to program new data (received from the host system) to a particular portion and to relocate previously programmed data to the same particular portion. In this way, rather than using two different write cursors for programming and for performing data relocation, a single write cursor can be utilized which reduces the overall amount of resources consumed by the memory sub-system. This improves the overall efficiencies of operating the memory sub-system.

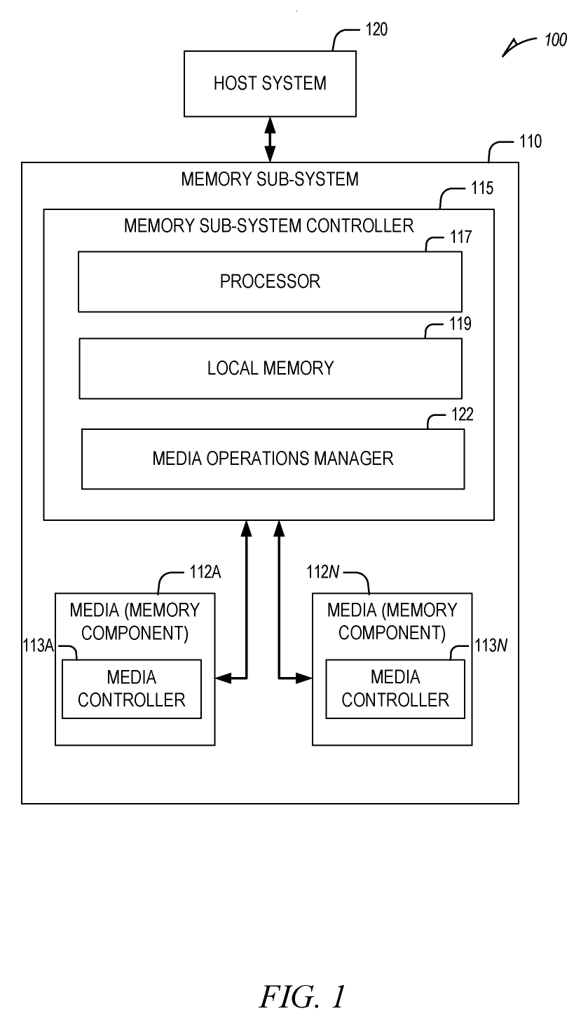

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

In some cases, the memory sub-system includes an optional feature, such as an FDP feature that defines RGs and RUs. This protocol enables remote hosts to control data storage on the memory sub-systems. Some memory sub-systems define or generate virtual memory groups, such as virtual RUs. These virtual memory groups can be implemented by multiple different physical memory components and/or portions of physical memory components. By defining virtual memory groups, the data block size available to a host to store data can be kept constant across different technologies of memory sub-systems and as different portions of various blocks reach their end of life, such as when they reach their maximum PECs.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as "garbage collection data." “User data” can include host data and garbage collection data. "System data" hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction coding (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with local embedded controllers for memory management within the same memory device package.

Certain memory systems group the physical memory components into different RGs where each RG includes multiple RUs. The RUs can be of any size that is at least as large as the LUN. Namely, the RU can be the size of a single block or a block stripe (BS) (e.g., can be the size of a superblock spanning multiple memory dies). In some cases, each RU and/or RG can correspond to and be implemented by a different SSD. These memory systems allow hosts to store data to certain RG and/or to certain RUs within those RGs using corresponding RU handles (write pointers or write cursors). This provides greater control to the host as to where data is physically stored. Once data is stored to an individual RG, garbage collection operations can be performed but are limited to folding data using the RUs of the individual RG. Namely, in some cases, data cannot be folded into any RU or another RG, but all remains stored in the same RG.

Conventional memory sub-systems fold data within an individual RG using a dedicate folding cursor. Namely, for each RG, conventional memory sub-systems use an RU handle to program new data received from the host system and can use a separate folding cursor to relocate previously programmed data to a new RU. Such implementations require two write cursors for each RG which can cause the number of write cursors needed to grow very quickly as additional RG are created. This can adversely impact performance of garbage collection operations and other memory operations used in FDP systems. This can slow down the overall memory sub-system and can prolong performing other operations, which introduces inefficiencies.

Examples of the present disclosure address the above and other deficiencies by providing a memory controller that can use the same RU handle or write cursor to program new data received from the host system as that used for relocating previously programmed data in a particular RG (e.g., a set of regions). Specifically, the disclosed controller can program the data to each region of different sets of physical regions (e.g., RGs) using a respective write cursor (e.g., RU handle). In response to determining that garbage collection operations are needed for an individual set of regions (e.g., when a maximum number of regions have been programmed in the individual set of regions), the controller can relocate valid data from a second portion of the individual set of regions to a first portion of the individual set of regions using a first write cursor being used to program new data to the first portion. In this way, rather than using two different write cursors for programming and for performing data relocation, a single write cursor can be utilized which reduces the overall amount of resources consumed by the memory sub-system. This improves the overall efficiencies of operating the memory sub-system. This increases the overall efficiency of operating the memory sub-system.

In some examples, the memory controller stores a set of data across a plurality of memory components of the set of memory components. A first of the plurality of components can be configured to store data in a first set of regions using a first write cursor. A second of the plurality of components can be configured to store data in a second set of regions using a second write cursor. The memory controller can program data (e.g., new data) received from a host system, in a first portion of the first set of regions using the first write cursor. The memory controller can relocate previously programmed data from a second portion of the first set of regions to the first portion of the first set of regions using the first write cursor. The memory sub-system can include an FDP compliant storage device. The memory controller can group the set of memory components into a plurality of RGs, each RG of the plurality of RGs including a subset of RUs. The first set of regions can include a first subset of RUs and the second set of regions can include a second subset of RUs.

In some examples, the previously programmed data includes valid data from one or more RUs of the first subset of RUs. The first portion of the first set of regions can include an individual RU of the first subset of RUs different from the one or more RUs of the first subset of RUs. Data can be programmed to the second set of regions using a second write cursor while the data is programmed to the first portion of the first set of regions using the first write cursor.

The first write cursor can include a first RU handle. The second write cursor can include a second RU handle. The first portion can include a BS and the previously programmed data can be relocated to the BS while the BS is open and prior to the BS being closed. In some cases, the controller determines that a maximum number of portions of the first set of regions has been programmed. The controller, in response to determining that the maximum number of portions of the first set of regions has been programmed, initiates garbage collection operations on the first set of regions. The previously programmed data can be relocated in response to initiating the garbage collection operations on the first set of regions. The previously programmed data can include folding victims. The maximum number can include eight or more block stripes.

In some examples, the controller can initiate garbage collection operations prior to programming a maximum number of regions in the first set regions. The controller can initiate relocation of previously programmed data between portions of the first set of regions using the first write cursor in response to determining that a first number of portions has been programmed with data in the first set of regions. The controller can initiate relocation of previously programmed data between portions of the second set of regions using a second write cursor in response to determining that a second number of portions has been programmed with data in the second set of regions. The second number can be smaller than the first number or can be larger than the first number.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N(also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed. In some cases, the first memory component 112A can be implemented by a first SSD (or a first independently operable memory sub-system) and the second memory component 112N can be implemented by a second SSD (or a second independently operable memory sub-system).

In some examples, one of the memory components 112A to 112N can be associated with a first RG and another one of the memory components 112A to 112N can be associated with a second RG. In some cases, a first portion (e.g., a first BS or first memory block) of the memory components 112A to 112N can be associated with a first RU of the first RG and a second portion (e.g., a second BS or second memory block) of the memory components 112A to 112N can be associated with a second RU of the second RG. The memory sub-system 110 can have any number of RGs and any number of RUs within each RG and can, in some cases, implement the FDP. In some cases, each RG can include a different number or different maximum number of RUs. Once that maximum number is reached, garbage collection operations can be initiated.

In some examples, a memory or register can be associated with all of the memory components 112A to 112N and can store a table that maps portions of the memory components 112A to 112N to different groups of RGs. The table can specify which set of memory components 112A to 112N maps to or is associated with and grouped with a first RG, and within that set, which portions of the memory components 112A to 112N correspond to RUs within the first RG. Similarly, the table can specify which other set of memory components 112A to 112N maps to or is associated with and grouped with a second RG, and within that set, which portions of the memory components 112A to 112N correspond to RUs within the second RG. In some cases, the table stores a list of LBAs associated with each RU.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of a memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components and/or storage devices. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe (BS) and a single second row that spans a second set of the pages or blocks of the memory components 112A to 112N can correspond to or be grouped as a second block stripe (BS).

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management, garbage collection operations, different near miss ECC operations, and/or different dynamic data refresh.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112A to 112N. The configuration data can describe the lifetime (maximum) PEC values and/or reliability grades associated with different groups of the memory components 112A to 112N and/or different blocks within each of the memory components 112A to 112N and/or different RUs, and/or different RGs and/or sizes of storage regions (e.g., RUs, RGs, and/or blocks) of each memory component used to implement the memory sub-system.

For example, the memory sub-system may be made up of three memory components (e.g., three SSDs). A first of the three memory components may be configured to store data in a first set of regions each being a first size; a second of the three memory components may be configured to store data in a second set of regions each being a second size; and a third of the three memory components may be configured to store data in a third set of regions each being a third size. The first, second, and third sizes can be equal or non-equal. The configuration data can specify the sizes of the set of regions of each of the memory components.

In some examples, commands or operations received from the host system 120 can include a write command, which can specify or identify an individual RG and/or RU within the individual RG to which to program data. Based on the individual RG specified by the write command, the memory sub-system controller 115 can determine the memory components 112A to 112N associated with the individual RG and can generate a write pointer (RU handle) that is used to program the data to the determined memory components 112A to 112N. In some cases, the host system 120 can select an individual RU handle and can program data using the selected individual RU handle. Each RG can be associated with a different RU handle (or write pointer). For example, a first RG can use a first write pointer (first RU handle) to program data into a first set of RUs of the first RG and a second RG can use a second write pointer (second RU handle) to program data into a second set of RUs of the second RG. Any data that is written by the host system 120 using the individual RU handle can be stored to a specified RU that is associated with the RU handle. Based on which RU handle is used by the host system 120 to program data, different RUs are used by the host system 120 to physically store the data simultaneously. In some cases, the host system 120 can track which LBAs are associated with which RU handles and can determine based on the LBAs the RUs in which the data is stored.

In some examples, the commands or operations received from the host system 120 can include a write command, which can specify or identify an individual virtual memory group in which to program data. Based on the virtual memory group specified by the write command, the memory sub-system controller 115 can determine the memory components 112A to 112N (e.g., the RUs, LBAs, and/or RGs) associated with the virtual memory group and can program the data into the determined memory components 112A to 112N. In some cases, the host system 120 can select an individual virtual memory group to invalidate and can issue an invalidate command to the memory sub-system controller 115 identifying the individual virtual memory group. In response, the memory sub-system controller 115 can identify a list of memory components 112A to 112N (e.g., one or more RUs and/or RGs) that are used to store the data for the individual virtual memory group. The memory sub-system controller 115 can then find the valid data in the list of memory components 112A to 112N that belong to another virtual memory group. The memory sub-system controller 115 can then re-write the found valid data from the other virtual memory group to a different memory component(s) 112A to 112N.

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which are raw memory devices combined with local embedded controllers (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to use the same RU handle or write cursor to program new data received from the host system as that which is used to relocate previously programmed data in a particular RG (e.g., a set of regions). Specifically, the media operations manager 122 can program the data to each region of different sets of physical regions (e.g., RGs) using a respective write cursor (e.g., RU handle). In response to determining that garbage collection operations are needed for an individual set of regions (e.g., when a maximum number of regions have been programmed in the individual set of regions), the media operations manager 122 can relocate valid data from a second portion of the individual set of regions to a first portion of the individual set of regions using a first write cursor being used to program new data to the first portion. In this way, rather than using two different write cursors for programming and for performing data relocation, a single write cursor can be utilized which reduces the overall amount of resources consumed by the memory sub-system 110. This improves the overall efficiencies of operating the memory sub-system 110. This increases the overall efficiency of operating the memory sub-system 110.

Specifically, the media operations manager 122 can store a set of data across a plurality of memory components of a set of memory components, a first of the plurality of components being configured to store data in a first set of regions using a first write cursor, and a second of the plurality of components being configured to store data in a second set of regions using a second write cursor. The media operations manager 122 programs data, received from a host system, in a first portion of the first set of regions using the first write cursor. The media operations manager 122 relocates previously programmed data from a second portion of the first set of regions to the first portion of the first set of regions using the first write cursor, such as in the process of performing one or more garbage collection operations.

Depending on the example, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

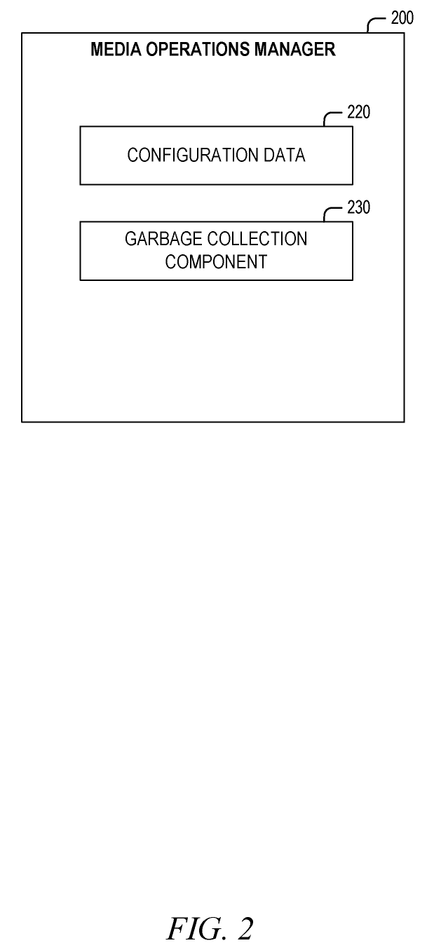

FIG. 2 is a block diagram of an example media operations manager 200 (corresponding to media operations manager 122 of FIG. 1), in accordance with some implementations of the present disclosure. As illustrated, the media operations manager 200 includes configuration data 220 and a garbage collection component 230. For some examples, the media operations manager 200 can differ in components or arrangement (e.g., less or more components) from what is illustrated in FIG. 2.

The configuration data 220 accesses and/or stores configuration data associated with the memory components 112A to 112N of FIG. 1. In some examples, the configuration data 220 is programmed into the media operations manager 200. For example, the media operations manager 200 can communicate with the memory components 112A to 112N to obtain the configuration data and store the configuration data 220 locally on the media operations manager 122. In some examples, the media operations manager 122 communicates with the host system 120 of FIG. 1. The host system 120 receives input from an operator or user that specifies parameters including virtual memory group assignments to physical memory components, lifetime (maximum) PEC values of different bins, groups, blocks, block stripes, memory dies, RUs, RGs, and/or sets of the memory components 112A to 112N, and/or group assignments that define the sizes of different RU and RGs or regions of the memory components used to store data. The media operations manager 122 can receive configuration data from the host system 120 and stores the configuration data in the configuration data 220. In some cases, the media operations manager 122 accesses region size information from each of the memory components used to store data in the memory sub-system 110 of FIG. 1 and can communicate that information to the host system 120.

The configuration data 220 can store a map that identifies which sets of memory components 112A to 112N are used to implement different RGs. The configuration data 220 can store a table that maps different virtual memory groups to different physical memory components 112A to 112N (e.g., different RUs, RGs, and/or LBAs). For example, the configuration data 220 can store a map that associates a first RG with a first portion of the memory components 112A to 112N (e.g., a first die or first set of LBAs) and that associates a second RG with a second portion of the memory components 112A to 112N (e.g., a second die or second set of LBAs). The configuration data 220 can store a table that associates a first virtual memory group with a first portion of the memory components 112A to 112N (e.g., a first die, a first portion of a first RU) and that associates a second virtual memory group with a second portion of the memory components 112A to 112N (e.g., a second die or second portion of the first RU and a first portion of a second RU). The map can store an indication of the physical addresses or LUN of the first portion of the memory components 112A to 112N associated with the first RG and/or virtual memory group and an indication of the physical addresses or LUN of the second portion of the memory components 112A to 112N associated with the second RG and/or virtual memory group.

The garbage collection component 230 can perform garbage collection operations for each RG in an efficient manner. Specifically, the garbage collection component 230 can determine that an individual RG has reached a maximum number of RUs in which data has been programmed or that some other condition has been met for triggering garbage collection operations. In such cases, the garbage collection component 230 can identify a set of victims (e.g., previously programmed data in one or more RUs of the individual RG). The garbage collection component 230 can then relocate the set of victims from the one or more RUs in which they are stored to a current RU being programmed with new data by the host system 120. The garbage collection component 230 can use the same RU handle to program both the new data received from the host system 120 and the set of victims. Once the set of victims finish being relocated to the current RU, the one or more RUs that stored the set of victims can be erased and made available to store new data. When the current RU reaches a threshold size or capacity, the current RU is closed to prevent further data from being programmed into the current RU. Additional data that is received from the host system 120 is programmed into a new RU of the individual RG (e.g., one of the RUs [from which the set of victims have been transferred] that have been erased).

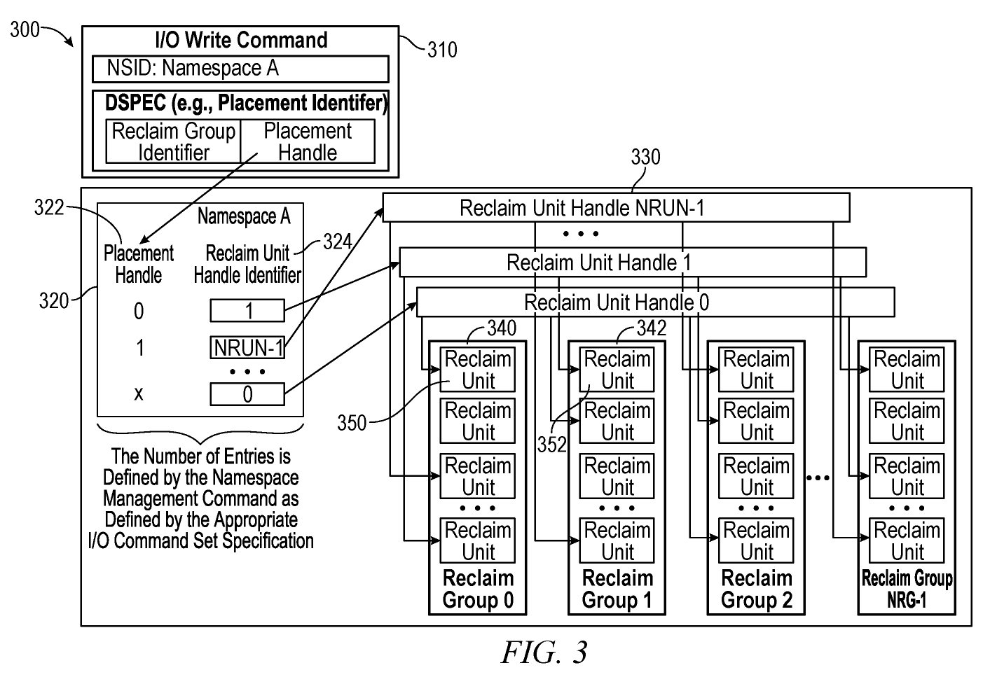

For example, FIG. 3 is a block diagram of an example RG system 300 implementation of the memory sub-system 110 of FIG. 1. The RG system 300 includes a placement handle component 320 that is used to store the map of different groups (e.g., the map stored by the configuration data 220 of FIG. 2). The RG system 300 can receive a write command 310 that specifies at least an RG and/or a placement handle. The placement handle component 320 can search the map using the placement handle 322 to identify the RU 324 associated with the specified RG. The RG system 300 can then generate a write pointer 330 to write data to the identified RU 324.

As shown in FIG. 3, multiple RGs are defined. For example, the RG system 300 includes a first RG 340 and a second RG 342. The first RG 340 includes a first group of RUs 350 (e.g., that each stores a different block stripe). The second RG 342 includes a second group of RUs 352. In some cases, the first RG 340 can represent a single memory die and the second RG 342 represents another single memory die. In some cases, the first RG 340 can represent a first SSD and the second RG 342 represents a second SSD. Each RU in the first group of RUs 350 is implemented by a portion of the memory components 112A to 112N, such as blocks, planes, superblocks, BSs, pages, and so forth.

Similarly, each RU in the second group of RUs 352 is implemented by a different portion of the memory components 112A to 112N, such as blocks, planes, superblocks, pages, and so forth. All of the garbage collection operations performed within RUs of an individual RG can be constrained to that individual RG using the RU handle for that individual RG and without using a separate folding cursor. For example, garbage collection operations performed on an individual RU of the first group of RUs 350 fold data using only the RUs in the first group of RUs 350, and garbage collection operations performed on an individual RU of the second group of RUs 352 fold data using only the RUs in the second group of RUs 352.

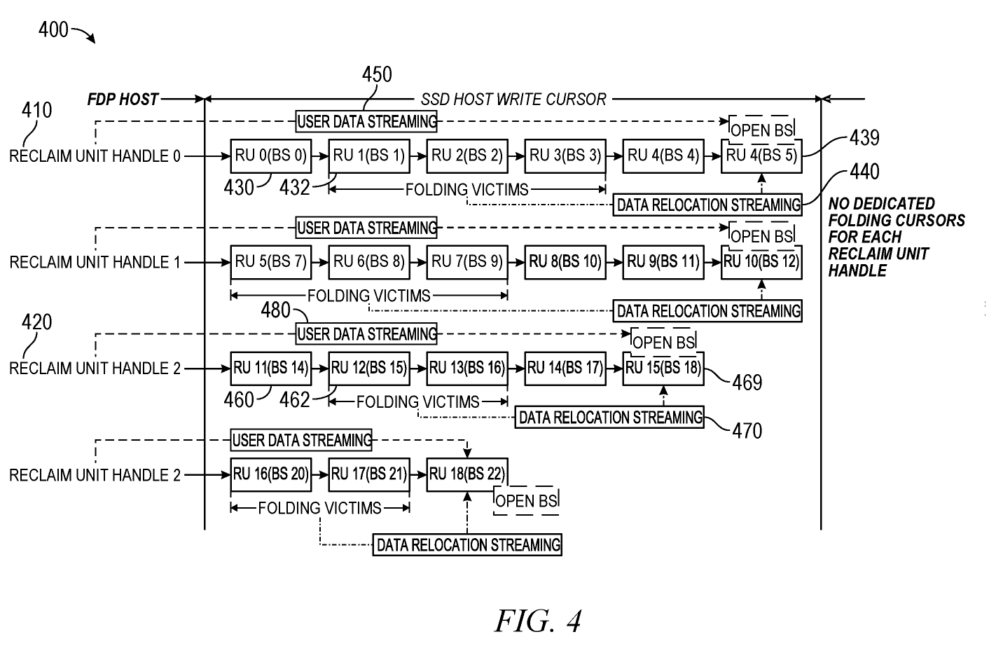

In some examples, as shown in the diagram 400 of FIG. 4, the media operations manager 200 of FIG. 2 can program data received from the host system 120 of FIG. 1 into a first RG that includes multiple RUs (e.g., a first RU 430, a second RU 432, and third RU 439). Once a given RU is closed, the media operations manager 200 begins programming new data into a new RU. For example, the first RG can program data into the first RU 430 using a first RU handle 410. Once the first RU 430 has reached a maximum capacity or threshold amount of programmed data, the media operations manager 200 closes the first RU 430 (to prevent additional data from being programmed into the first RU 430 and opens a new RU (e.g., the second RU 432) and programs new data into the new RU. The different RUs can be referred to as different sets of regions of the RG.

In some cases, the media operations manager 200 begins programming new data into a current RU (e.g., the third RU 439). Also, the media operations manager 200 can determine that a maximum number of RUs has been reached for the first RG meaning that additional new RUs cannot be opened. In such cases, the media operations manager 200 can instruct the garbage collection component 230 of FIG. 2 to perform garbage collection operations on the first RG to free up RUs in the first RG. The garbage collection component 230 can identify a set of folding victims by searching previously closed RUs for valid data. For example, the garbage collection component 230 can identify a first portion of valid data in the second RU 432 and a second portion of valid data in another RU of the first RG. In such cases, the garbage collection component 230 can begin relocating the first portion of valid data from the second RU 432 and the second portion of valid data from the other RU of the first RG to the third RU 439 that is currently open and being programmed with new data 450 received from the host system 120.

The garbage collection component 230 can use the first RU handle 410 to perform both operations of programming the new data 450 received from the host system 120 and relocating the first and second portions of valid data from previously closed RUs into the third RU 439. Namely, the garbage collection component 230 identifies the currently open RU and stores the previously programmed valid data while also programming newly received data from the host system 120. The garbage collection component 230 can determine that the folding victims have successfully been relocated. In response, the garbage collection component 230 can erase the RUs from which the folding victims were relocated to create new free RUs in the first RG.

Similarly, the media operations manager 200 can program data received from the host system 120 into a second RG that includes multiple RUs (e.g., a first RU 460, a second RU 462, and third RU 469). The data can be programmed using a second RU handle 420 simultaneously or in parallel with programming data by the first RU handle 410 into the first RG. Once a given RU is closed, the media operations manager 200 begins programming new data into a new RU of the second RG.

In some cases, the media operations manager 200 begins programming new data into a current RU (e.g., the third RU 469). Also, the media operations manager 200 can determine that a maximum number of RUs has been reached for the second RG meaning that additional new RUs cannot be opened. The maximum number of RUs or threshold number of RUs of the second RG can be smaller than the maximum number of RUs or threshold number of RUs of the first RG. In such cases, garbage collection operations can be initiated more frequently for the second RG than the first RG as fewer RUs are available to program new data.

The media operations manager 200 can instruct the garbage collection component 230 to perform garbage collection operations on the second RG to free up RUs in the second RG. The garbage collection component 230 can identify a set of folding victims by searching previously closed RUs for valid data. For example, the garbage collection component 230 can identify a portion of valid data in the second RU 462. In such cases, the garbage collection component 230 can begin relocating the portion of valid data from the second RU 462 of the second RG to the third RU 469 that is currently open and being programmed with new data 480 received from the host system 120.

The garbage collection component 230 can use the second RU handle 420 to perform both operations of programming the new data 480 received from the host system 120 and relocating the portions of valid data from previously closed RUs into the third RU 469. Namely, the garbage collection component 230 identifies the currently open RU and stores the previously programmed valid data while also programming newly received data from the host system 120. The garbage collection component 230 can determine that the folding victims have successfully been relocated. In response, the garbage collection component 230 can erase the RUs from which the folding victims were relocated to create new free RUs in the second RG. The garbage collection operations in the second RG can be performed in parallel with performing garbage collection operations in the first RG or any other RG of the memory sub-system 110.

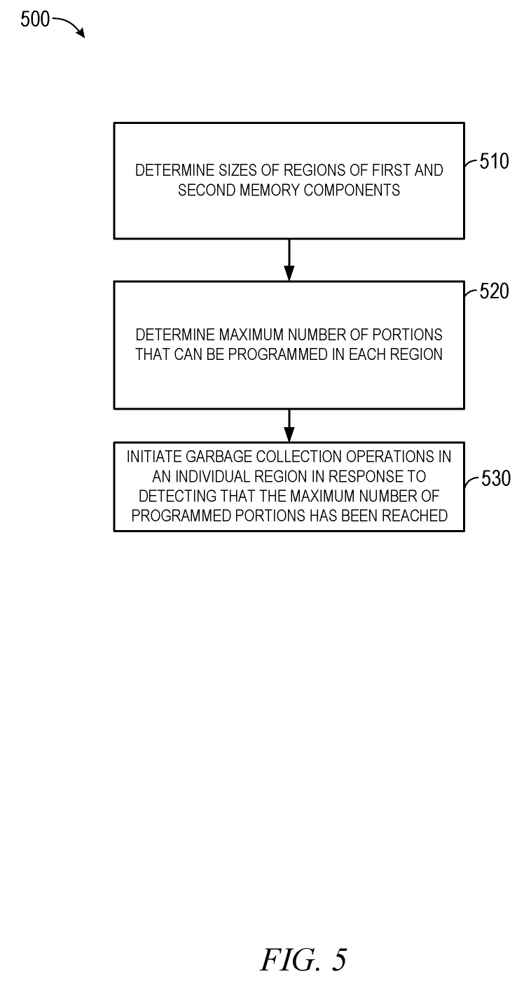

FIG. 5 is a flow diagram of an example method 500 to perform garbage collection operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 510, with a media operations manager 200 of FIG. 2 determining sizes of regions of first and second memory components, such as sizes of different RGs. The media operations manager 200, at operation 520, determines the maximum number of portions that can be programmed in each region. For example, the media operations manager 200 can determine the maximum number of RUs available in each RG of the set of memory components 112A to 112N. At operation 530, the media operations manager 200 initiates garbage collection operations in an individual region (e.g., individual RG) in response to detecting that the maximum number of programmed portions (e.g., RUs or block stripes) has been reached in that individual region.

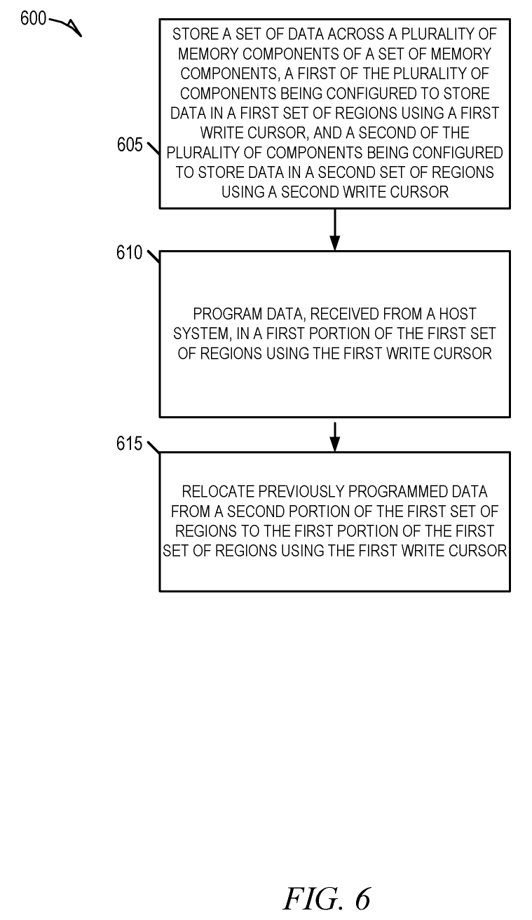

FIG. 6 is a flow diagram of an example method 600 to perform garbage collection operations, in accordance with some examples. The method 600 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 600 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 6, the method (or process) 600 begins at operation 605, with a media operations manager 122 of FIG. 1 of a memory sub-system (e.g., memory sub-system 110) storing a set of data across a plurality of memory components of a set of memory components 112A to 112N of FIG. 1, a first of the plurality of components being configured to store data in a first set of regions (e.g., a first RG) using a first write cursor, and a second of the plurality of components being configured to store data in a second set of regions (e.g., a second RG) using a second write cursor. Then, at operation 610, the media operations manager 122 programs data, received from a host system, in a first portion (e.g., a first RU or first BS) of the first set of regions (e.g., a first set of RUs) using the first write cursor (e.g., a first RU handle). At operation 615, the media operations manager 122 relocates previously programmed data from a second portion (e.g., a second RU or second BS) of the first set of regions (e.g., the first RG) to the first portion (e.g., the first RU or first BS) of the first set of regions using the first write cursor.

In view of the disclosure above, various examples are set forth below. It should be noted that one or more features of an example, taken in isolation or combination, should be considered within the disclosure of this application.

Example 1. A system comprising: a set of memory components of a memory sub-system; and at least one processing device operatively coupled to the set of memory components, the at least one processing device being configured to perform operations comprising: storing a set of data across a plurality of memory components of the set of memory components, a first of the plurality of components being configured to store data in a first set of regions using a first write cursor, and a second of the plurality of components being configured to store data in a second set of regions using a second write cursor; programming data, received from a host system, in a first portion of the first set of regions using the first write cursor; and relocating previously programmed data from a second portion of the first set of regions to the first portion of the first set of regions using the first write cursor.

Example 2. The system of Example 1, wherein the memory sub-system includes a Flexible Data Placement (FDP) compliant storage device.

Example 3. The system of Example 2, the operations further comprising: grouping the set of memory components into a plurality of reclaim groups (RGs), each RG of the plurality of RGs comprising a subset of reclaim units (RUs), the first set of regions comprising a first subset of RUs and the second set of regions comprising a second subset of RUs.

Example 4. The system of Example 3, wherein the previously programmed data comprises valid data from one or more RUs of the first subset of RUs, and wherein the first portion of the first set of regions comprises an individual RU of the first subset of RUs different from the one or more RUs of the first subset of RUs.

Example 5. The system of any one of Examples 1-4, wherein the data is programmed to the second set of regions using the second write cursor while the data is programmed to the first portion of the first set of regions using the first write cursor.

Example 6. The system of Example 5, wherein the first write cursor comprises a first reclaim unit handle, and wherein the second write cursor comprises a second reclaim unit handle.

Example 7. The system of any one of Examples 1-6, wherein the first portion comprises a block stripe, and wherein the previously programmed data is relocated to the block stripe while the block stripe is open and prior to the block stripe being closed.

Example 8. The system of any one of Examples 1-7, the operations comprising: determining that a maximum number of portions of the first set of regions has been programmed; and in response to determining that the maximum number of portions of the first set of regions has been programmed, initiating garbage collection operations on the first set of regions.

Example 9. The system of Example 8, wherein the previously programmed data is relocated in response to initiating the garbage collection operations on the first set of regions.

Example 10. The system of any one of Examples 8-9, wherein the previously programmed data comprises folding victims.

Example 11. The system of any one of Examples 8-10, wherein the maximum number comprises eight block stripes.

Example 12. The system of any one of Examples 1-11, the operations comprising: initiating the garbage collection operations prior to programming a maximum number of regions in the first set regions.

Example 13. The system of any one of Examples 1-12, the operations comprising: initiating relocation of the previously programmed data between portions of the first set of regions using the first write cursor in response to determining that a first number of portions has been programmed with data in the first set of regions; and initiating relocation of the previously programmed data between portions of the second set of regions using the second write cursor in response to determining that a second number of portions has been programmed with data in the second set of regions.

Example 14. The system of Example 13, wherein the second number is smaller than the first number.

Methods and computer-readable storage medium with instructions for performing any one of the above examples are provided as follows.

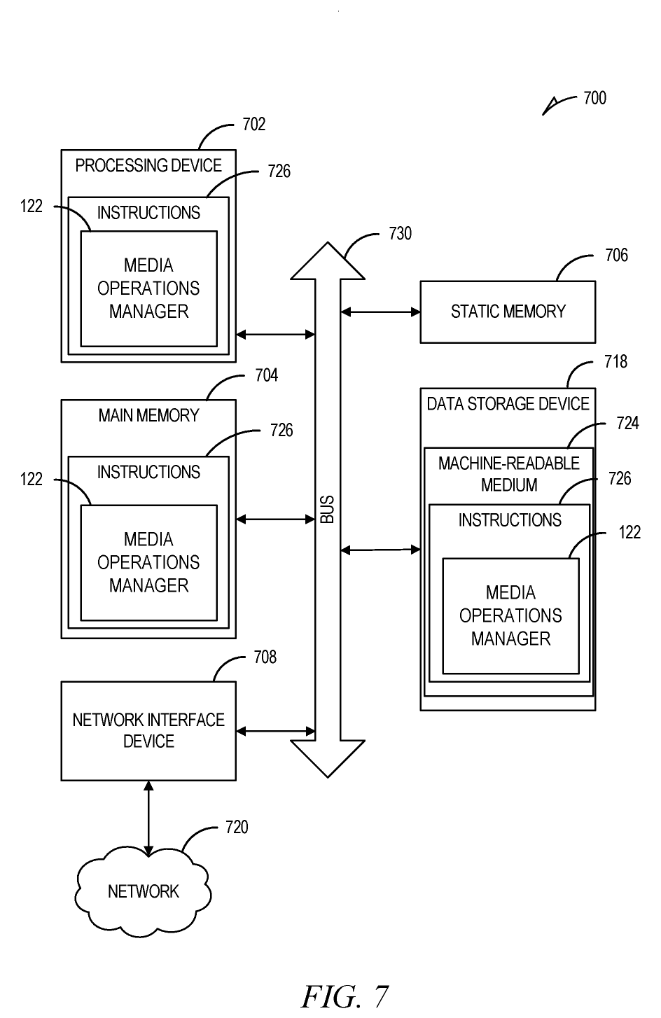

FIG. 7 illustrates an example machine in the form of a computer system 700 within which a set of instructions can be executed for causing the machine to perform any one or more of the methodologies discussed herein. In some examples, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), a network processor, or the like. The processing device 702 is configured to execute instructions 726 for performing the operations and steps discussed herein. The computer system 700 can further include a network interface device 708 to communicate over a network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one example, the instructions 726 implement functionality corresponding to the media operations manager 122 of FIG. 1. While the machine-readable storage medium 724 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system’s memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, the disclosure has been described with reference to specific examples thereof. It will be evident that various modifications can be made thereto without departing from the broader scope of the disclosure as set forth in the following claims. The specification and drawings are, accordingly, to be regarded in an illustrative sense rather than a restrictive sense.

What is claimed is:

1. A system comprising:
a set of memory components of a memory sub-system;
at least one processing device operatively coupled to the set of memory components, the at least one processing device being configured to perform operations comprising:
storing a set of data across a plurality of memory components of the set of memory components, a first of the plurality of components being configured to store data in a first set of regions using a first write cursor, and a second of the plurality of components being configured to store data in a second set of regions using a second write cursor;
programming data, received from a host system, in a first portion of the first set of regions using the first write cursor; and
relocating previously programmed data from a second portion of the first set of regions to the first portion of the first set of regions using the first write cursor.

2. The system of claim 1, wherein the memory sub-system includes a Flexible Data Placement (FDP) compliant storage device.

3. The system of claim 2, the operations further comprising:
grouping the set of memory components into a plurality of reclaim groups (RGs), each RG of the plurality of RGs comprising a subset of reclaim units (RUs), the first set of regions comprising a first subset of RUs and the second set of regions comprising a second subset of RUs.

4. The system of claim 3, wherein the previously programmed data comprises valid data from one or more RUs of the first subset of RUs, and wherein the first portion of the first set of regions comprises an individual RU of the first subset of RUs different from the one or more RUs of the first subset of RUs.

5. The system of claim 1, wherein the data is programmed to the second set of regions using the second write cursor while the data is programmed to the first portion of the first set of regions using the first write cursor.

6. The system of claim 5, wherein the first write cursor comprises a first reclaim unit handle, and wherein the second write cursor comprises a second reclaim unit handle.

7. The system of claim 1, wherein the first portion comprises a block stripe, and wherein the previously programmed data is relocated to the block stripe while the block stripe is open and prior to the block stripe being closed.

8. The system of claim 1, the operations comprising:
determining that a maximum number of portions of the first set of regions has been programmed; and
in response to determining that the maximum number of portions of the first set of regions has been programmed, initiating garbage collection operations on the first set of regions.

9. The system of claim 8, wherein the previously programmed data is relocated in response to initiating the garbage collection operations on the first set of regions.

10. The system of claim 8, wherein the previously programmed data comprises folding victims.

11. The system of claim 8, wherein the maximum number comprises eight block stripes.

12. The system of claim 1, the operations comprising:
initiating the garbage collection operations prior to programming a maximum number of regions in the first set of regions.

13. The system of claim 1, the operations comprising:
initiating relocation of the previously programmed data between portions of the first set of regions using the first write cursor in response to determining that a first number of portions has been programmed with data in the first set of regions; and
initiating relocation of the previously programmed data between portions of the second set of regions using the second write cursor in response to determining that a second number of portions has been programmed with data in the second set of regions.

14. The system of claim 13, wherein the second number is smaller than the first number.

15. A method comprising:
storing a set of data across a plurality of memory components of a set of memory components, a first of the plurality of components being configured to store data in a first set of regions using a first write cursor, and a second of the plurality of components being configured to store data in a second set of regions using a second write cursor;
programming data, received from a host system, in a first portion of the first set of regions using the first write cursor; and
relocating previously programmed data from a second portion of the first set of regions to the first portion of the first set of regions using the first write cursor.

16. The method of claim 15, wherein a memory sub-system comprising the set of memory components includes a Flexible Data Placement (FDP) compliant storage device.

17. The method of claim 16, comprising:
grouping the set of memory components into a plurality of reclaim groups (RGs), each RG of the plurality of RGs comprising a subset of reclaim units (RUs), the first set of regions comprising a first subset of RUs and the second set of regions comprising a second subset of RUs.

18. The method of claim 17, wherein the previously programmed data comprises valid data from one or more RUs of the first subset of RUs, and wherein the first portion of the first set of regions comprises an individual RU of the first subset of RUs different from the one or more RUs of the first subset of RUs.

19. The method of claim 15, wherein the data is programmed to the second set of regions using a second write cursor while the data is programmed to the first portion of the first set of regions using the first write cursor.

20. A non-transitory computer-readable storage medium comprising instructions that, when executed by at least one processing device, cause the at least one processing device to perform operations comprising:
storing a set of data across a plurality of memory components of a set of memory components, a first of the plurality of components being configured to store data in a first set of regions using a first write cursor, and a second of the plurality of components being configured to store data in a second set of regions using a second write cursor;
programming data, received from a host system, in a first portion of the first set of regions using the first write cursor; and
relocating previously programmed data from a second portion of the first set of regions to the first portion of the first set of regions using the first write cursor.
